(19) United States
(12) Patent Application Publication
(10) Pub. No.: US 2024/0202673 A1
(43) Pub. Date: Jun. 20, 2024

(54) MAXIMIZING PAYMENT OPTIONS WITH A TRUSTED CHAIN

(71) Applicant: INTERNATIONAL BUSINESS MACHINES CORPORATION, ARMONK, NY (US)

(72) Inventors: DIVYA MAHESHWARI, Scottsdale, AZ (US); SETHU ADHYAM, Bangalore (IN); DEEPAK Gupta, Indirapuram (IN); SIDDHARTH K. SARAYA, Raniganj (IN)

(21) Appl. No.: 18/068,518

(22) Filed: Dec. 19, 2022

(51) Int. Cl. G06Q 20/02; G06Q 20/38; G06Q 20/40

(52) U.S. Cl. CPC G06Q 20/02; G06Q 20/389; G06Q 20/4014

(57) ABSTRACT

Techniques are described with respect to a system, method, and computer product for maximizing payment options. An associated method includes generating a trusted chain comprising a plurality of data cells, the data cells including at least payment device data of a payment device associated with a user within a trusted network; transmitting a broadcast message to the plurality of data cells based on a selection of an option of the payment device, the broadcast message indicating occurrence of a transaction event within the trusted network involving the option; and generate a sub-chain of the trusted chain associated with the transaction event relating to the option. The method further including selecting the data cell of the plurality data cells comprising payment device data associated with the sub-chain; and closing the sub-chain based on a detected completion of the transaction event.

### FIELD

This disclosure relates generally to field of linked transactions, and more particularly to generating a trusted network to maximize payment device options.

### BACKGROUND

Due to payment device transactions becoming one of the most common type of transactions occurring on a daily basis, financial institutions and companies have began incentivizing both current and prospective payment device holders by optioning (e.g., providing offers for, etc.) payment devices including various characteristics and benefits. For example, payment devices may option variable interest rates based on the type of use, amount of use, location of use, etc. Additionally, payment devices may option various rewards, including but not limited to access to select venues, frequent flyer miles, cash back, or points, which can be redeemed for various benefits to the user, etc.

A trusted chain can be used to hold, track, transfer and verify sensitive information associated with trusted members of the chain within a trusted network, in which the validity of the trusted chain may be cryptographically verified. There are many possible mechanisms in which to verify the trusted chain including, but not limited to obtaining an end-entity certificate (e.g. a digital certificate, etc.) and verifying the digital signature of the certificate using keys (e.g. public keys, private keys, etc.) of the creator of the trusted chain. Because of the distributed nature of a trusted chain, it can be used to verify contents of the chain along with deduce relevant information associated with the trusted members of the chain, along with provide proof of an event (e.g. closing of a transaction, etc.). In particular, payment device information of payment devices (e.g., credit card benefits, credit card rewards, etc.) belonging to a trusted member may be ascertained in order to extend similar payment device options to other trusted members including data specific to the other trusted member. For example, the payment device information used by trusted members to obtain the payment devices is imperative to determining the details of interest rates and rewards payment device options; however, currently said information may be classified as sensitive data respective to a trusted member and subject to exposure to other trusted members of the chain. Furthermore, an individual who does not possess a particular payment device will not have the opportunity to receive the benefits bestowed to a payment device holder that is part of the same trusted network.

### SUMMARY

Embodiments relate to a method, system, and computer readable medium for maximizing payment options utilizing trusted chains and/or linked lists. In some embodiments, the computer-implemented method for maximizing payment options includes generating a trusted chain comprising a plurality of data cells, the data cells including at least payment device data of a payment device associated with a user within a trusted network; transmitting a broadcast message to the plurality of data cells based on a selection of an option of the payment device, the broadcast message indicating occurrence of a transaction event within the trusted network involving the option; generating a sub-chain of the trusted chain associated with the transaction event relating to the option; selecting the data cell of the plurality data cells comprising payment device data associated with the sub-chain; and closing the sub-chain based on a detected completion of the transaction event.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a trusted network payment device maximization environment, according to an exemplary embodiment;

FIG. 3 illustrates a payment device module, according to an exemplary embodiment;

FIG. 4 illustrates a flowchart depicting a method for maximizing payment options, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for maximizing payment options utilizing trusted chains and/or linked lists. Trusted chains and linked lists may be utilized to create a local trust network including trusted members that have the ability to provide consent for their respective data used in the trusted network. In particular, trusted chains and linked lists may be utilized in the context of payment device options in which the countless amount of payment device options and payment device incentives may be based on sensitive information specific to a trusted member who already possesses the payment device. Trusted chains and linked lists provide the ability to broadcast messages indicating transaction events of payment devices to data cells of the chains in order to not only share content, but also confirm occurrence of events (e.g. transactions, etc.). However, privileged or sensitive information of trusted members used to obtain the payment devices may be shared with other members of the trusted network. In addition, payment device benefits bestowed to a payment device holder in one trusted member in the trusted network are not bestowed to another trusted member who is not a holder a particular payment device due to the aforementioned limitations. Therefore, the present embodiments have the capacity to option payment device options to a trusted member of a trusted network based on the current payment devices in possession of other trusted members and sensitive data pertaining to the applying member, in which the aforementioned is performed in a manner where the sensitive/privileged information of trusted members is not shared with each other. In particular, the present embodiments facilitate network requests for a specific payment device for payment allowing network members to respond to the request, and facilitate secure completion of the purchase and compensate the requesting member. Thus, the present embodiments improve computing resources by optimizing data security in a trusted network.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch payment devices or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As described herein, a “payment device,” in various embodiments, is a credit card, debit card, gift card, near-field communication technology, virtual wallet, or any other applicable mechanism of payment known to those of ordinary skill in the art.

As described herein, a “payment option,” in various embodiments, is a reward, offer, benefit, incentive, etc. derived from utilization of a payment device.

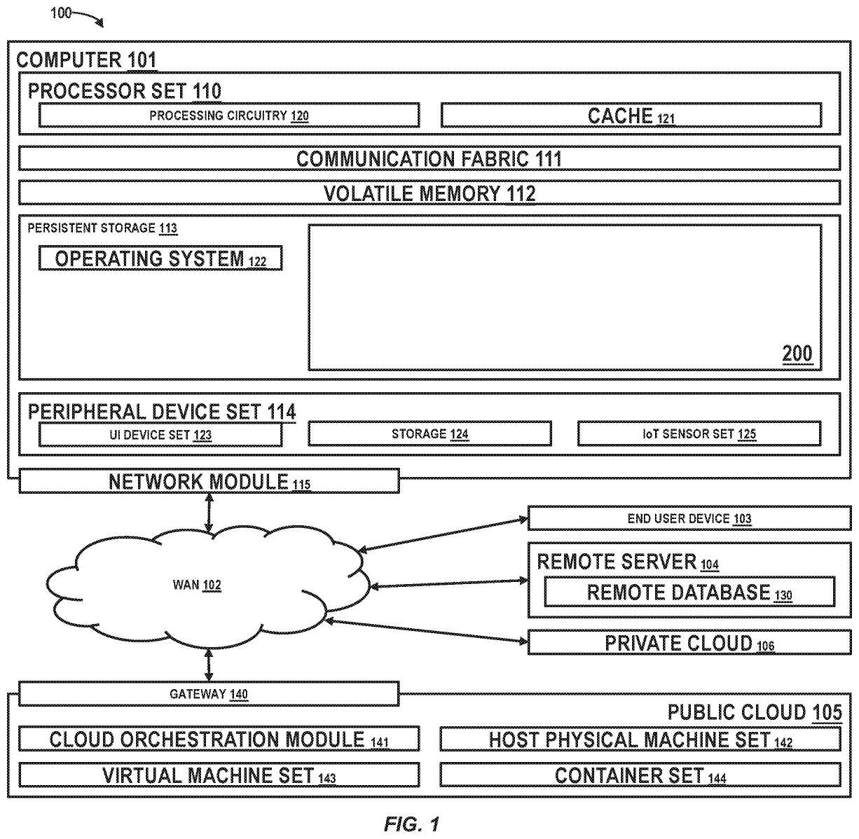

The following described exemplary embodiments provide a system, method and computer program for maximizing payment options. Referring now to FIG. 1, a computing environment 100 contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113, peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

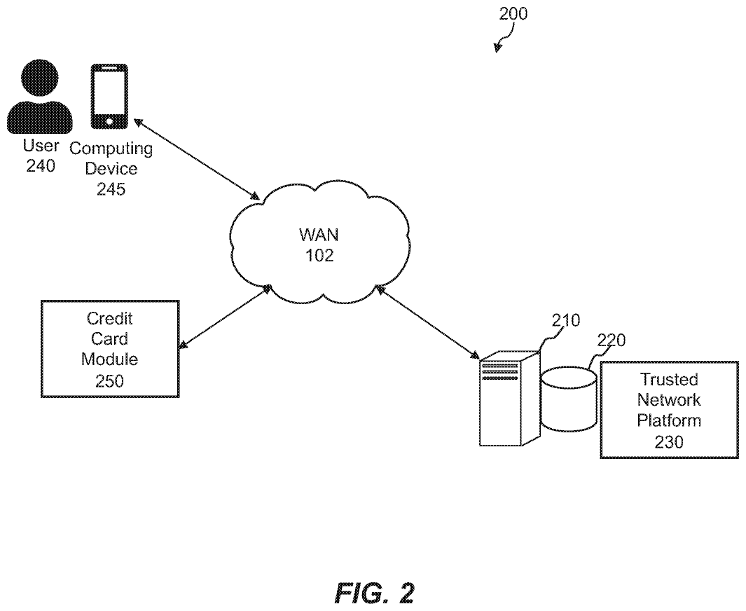

Referring now to FIG. 2, a functional block diagram of a networked computer environment illustrating a trusted network payment device maximization system 200 (hereinafter “system”) comprising a server 210 communicatively coupled to a database 220 and a trusted network platform 230, a user 240 associated with a computing device 245, and a payment device module 250, each of which are communicatively coupled over WAN 102 (hereinafter “network”) and data from the components of system 200 transmitted across the network is stored in database 220. Computing device 245 may take the form of a desktop computer, laptop computer, tablet computer, smart phone, smart watch or other wearable computer, computer-mediated reality device, mainframe computer, quantum computer or any other form of computer or mobile device now known or to be developed in the future that is capable of running a program, accessing a network or querying a database. It should be appreciated that FIG. 2 provides only an illustration of one implementation and does not imply any limitations with regard to the environments in which different embodiments may be implemented. Many modifications to the depicted environments may be made based on design and implementation requirements.

In another embodiment, payment device module 250 may operate on more than one computer, server computer, or some combination of computers and server computers, for example, a plurality of computers communicating across the network with a single server computer. In another embodiment, for example, payment device module 250 may operate on a plurality of server computers communicating across the network with a plurality of client computers. Alternatively, payment device module 250 may operate on a network server communicating across the network with server 210 and a plurality of client computers. In some embodiments, trusted network platform 230 is communicatively coupled to payment device module 250 allowing trusted network platform 230 to function as a centralized platform for generating a private trust chain configured to allow users (i.e. user 240, in this embodiment), hereinafter “trusted members”, to share unique identifications (IDs) and user consent associated with payment device information utilized for the application, utilization, and management of payment devices. It should be noted that trusted network platform 230 may generate and manage trusted chains and linked lists comprising a plurality of nodes/data cells associated with the trusted chain and sub-chains, in which data cells are designed to include at least payment device data of a payment device associated with a user 240 or trusted member (including payment device data of the user 240's network, family, friends, etc.) derived from payment device module 250 along with data of transaction events of payment options (hereinafter referred to as “options”). Sub-chains may be associated with any transaction request of payment device module 250. As described herein, a “node” may perform a logical function in the sense that multiple nodes of different types can run on the same physical server. Nodes may be grouped in trust domains and are associated with logical entities that control them in various ways. Nodes may further include different types, such as a client or submitting-client node which submits a transaction-invocation to trusted members and/or the “creator” of the chain, and broadcasts transaction-proposals to an ordering service (e.g. ordering node), in which the creator is configured to serve as a route source of authority. Another type of node is a peer node which can receive user submitted transactions pertaining to one or more payment devices, commit the transactions and maintain a state and a copy of the ledger of the applicable trusted chain or linked list. Peers can also have the role of a creator, although it is not a requirement. An ordering-service-node or creator is a node running the communication service for all nodes, and which implements a delivery guarantee, such as a broadcast to each of the peer nodes in the system when committing transactions and modifying a world state of the trusted chain or linked list, which is another name for the trusted chain transaction which normally includes control and setup information. In a preferred embodiment, trusted network platform 230 may generate a private trusted chain composed of family and friends, hereinafter referred to as a “trusted network” comprising “trusted members”, in which user 240 is required to share one or more IDs and consent with the creator in order to be approved for entry into the trusted chain and become a member of the trusted network. In some embodiments, the private trusted chain is cryptographically verified and derived from root-level authority granted by the creator who may serve as a trust anchor for one or more digital certificates associated with payment device information and payment device transactions.

Trusted network platform 230 may include various layers of trusted network data, services (e.g. cryptographic trust services, virtual execution environment, etc.), and supporting physical computer infrastructure that may be used to receive and store new transactions and provide access to applicable trust members seeking to access data entries. Trusted network platform 230 may expose an interface that provides access to the virtual execution environment necessary to process the program code and engage the physical infrastructure of the trusted network. In addition, trusted network platform 230 may be used to verify transactions such as asset exchange transactions and keep information private.

Due to the distributed nature of various trusted chains and linked lists, they can be used to store user IDs that may be used later for validation of the identity and/or actions of user 240. However, trusted information in trust chain may be used to access resources or provide proof of an event (e.g. transaction involving a payment device, etc.). The problem with this use of trusted information lays in a distributed nature of a trusted chain because user sensitive/privileged information may be distributed to other trusted members and user 240 must rely on their security processes. However, the provided embodiments seek to circumvent this issue by providing network broadcast messages that utilize the trusted chain to prevent the aforementioned issue by requesting a response of trusted members who are holders of particular payment devices to a network broadcast transmitted by user 240 who is not a holder of the particular payment device. In other words, sub-chains correspond to transaction requests in which only user 240 and the applicable holder of the payment device including options associated with the transaction event may view detailed information of the transaction on the centralized platform, while other members of the trusted network may have reduced access privileges directed towards whether the transaction request of a sub-chain was initiated, fulfilled, and/or abandoned. For example, trusted members may view on the centralized platform a status of the transaction involving user 240 and the applicable payment option bearing trusted member; however, particular data said as credit card information, option information, etc. may be redacted. In a preferred embodiment, user 240 wishes to apply for a payment device and/or a payment option of a payment device of at least one trusted member of the trusted network, in which user 240 broadcasts a request via a broadcast message to a trusted member who has the payment device. The broadcast receiving trusted member determines whether to respond by confirming acceptance of the network broadcast, in which confirmation of acceptance signifies the trusted member's willingness to participate. It should be noted that the broadcast message is configured to indicate occurrence of a transaction event involving the payment device within the trusted network, in which a transaction event may include, but is not limited to the initiation, continuation, and/or finalization of any applicable transaction occurring involving individuals within the trusted network.

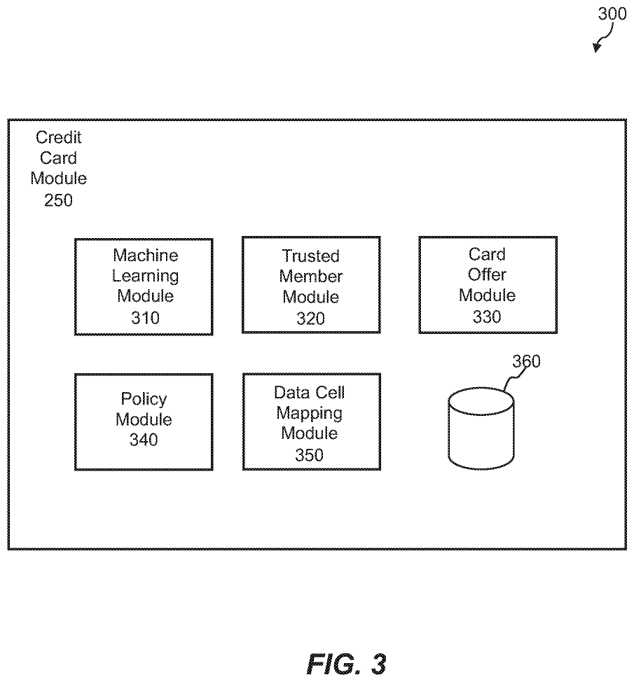

Payment device module 250 is configured to manage payment device information associated with trusted members including but not limited to payment device transactions, payment device specific interest rates, payment device balances, rewards information detailing various rewards programs that apply to credit/debit accounts associated with credit institutions, cashback rewards, frequent flyer miles information, reward points information, or any other applicable payment device information known to those of ordinary skill in the art. Payment device information may be derived from any applicable financial institution and/or payment device company subject to proper consent and authorization. In addition, payment device module 250 generates a forwarding link associated with one or more a product/service selected by user 240, a deal payment link, a transaction amount, an address of user 240, etc. It should be noted that the forwarding link is associated with a sub-chain of the trusted chain generated by trusted network platform 230, in which user 240 creates at least one data cell configured for trusted network platform 230 to initiate the sub-chain. The forwarding link is described in greater detail in reference to FIG. 3. Sub-chains are specific to payment transactions in which user 240 initiates the broadcast on an option of a payment device providing the option transaction amount and other applicable transaction specific details, the applicable trusted member receives the broadcast and either accepts or rejects the transaction proposal, in which upon the applicable trusted member agreeing to the transaction proposal user 240 instructs payment device module 250 to generate the forwarding link. Either user 240 or the applicable trusted member cancels the transaction or closes the sub-chain with the transaction payment.

Referring now to FIG. 3, an example architecture 300 of payment device module 250 is depicted, according to an exemplary embodiment. It should be noted that the communicative coupling of trusted network platform 230 and payment device module 250 is imperative to the layout of the trusted chain due to the fact that data cells created by user 240 including payment device information are mapped to the trusted chain by trusted network platform 230 ascertaining the payment device information from payment device module 250. In some embodiments, payment device module 250 includes a machine learning module 310, a trusted member module 320, a payment device option module 330, a policy module 340, a data cell mapping module 350, and a payment device module database 360.

Machine learning module 310 is configured to use one or more heuristics and/or machine learning models for performing one or more of the various aspects as described herein. In some embodiments, the machine learning models may be performed using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are considered to be within the scope of this disclosure. In particular, machine learning module 310 utilizes one or more machine learning models to generate predictions associated with which geographical regions, demographics, or other applicable attributes apply to trusted members and the payment device options/options of higher interest to trusted members. For example, machine learning module 310 may ascertain that payment device options/options associated with particular industries, venues, products, regions, etc. are more likely to entice trusted members of a trusted network based on training datasets including data derived from trusted member module 320.

Trusted member module 320 is designed to maintain updated records of applicable personal and payment device information pertaining to trusted members of the trusted network, in which each trusted member is associated with a trusted member record configured to be stored in payment device module database 360. In addition to managing information associated with trusted members and their payment device information, trusted member module 320 further manages the consents pertaining to trust members in regards to sharing derived and/or redacted payment device information, which is transmitted to policy module 340 for allocating viewing and access privileges of trusted members. It should be noted that a trusted network includes multiple trusted members and may further include multiple sub-chains derived from the trusted chain; however, a trusted member may be part of multiple trusted networks. Trusted member module 320 facilitates the ability for trusted members to be within multiple trusted networks by communicating with trusted network platform 230 in real-time in order to ensure that trusted members have access to appropriate information as well as ensuring that sensitive payment device information of trusted members is not made available to other trusted members.

Payment device option module 330 is configured to generate payment device options presented to user 240 based on analyses of payment device information of trusted members and/or the one or more actions performed by user 240 involving payment device transactions, rewards, benefits, etc. Payment device option module 330 is tasked with generating the forwarding link associated with the applicable data cell created by user 240 pertaining to sub-chain generated by trusted network platform 230. The forwarding link is designed to direct user 240 to a selected product associated with the applicable payment device that user 240 desires, a deal payment link (e.g. a shopping cart, transaction closing page, etc.), a transaction amount, an address of user 240 (serving as the buyer), etc. In some embodiments, user 240 proceeds to make a purchase via a received guest checkout option generated by payment device option module 330 resulting in payment device option module 330 automatically generating and transmitting the forwarding link to the trusted member who possesses the applicable payment device; thus, providing them the opportunity to close the transaction.

Policy module 340 is designed to determine one or more policies associated with the formulation of linking of the trusted chain or linked list. It should be noted that policy module 340 may determine which data cells are linked and/or should be linked to each other and which component of the sub-trusted chain are associated with the forwarding link generated by payment device module 250. Policies as described throughout pertain to guidelines associated with trusted members, trusted chains, and sub-chains of the trusted network relating to access, privileges, and any other applicable data associated with formulating the trusted chain, sub-chains, or linked lists. In some embodiments, policy module 340 generates code interpretations and/or derivatives of the logic that determine which components of payment device information of trusted members are protected and which are subject to view by user 240, and in some instances which component of payment device information of trusted members may be utilized by user 240. For example, if user 240 wishes to purchase a plane ticket for a specific airline associated with a specific payment device in which a trusted member is a holder. Policy module 340 determines a plurality of predefined values derived from payment device information associated with the specific payment device to be included in the applicable data cells, in which the data cells are mapped to the trusted chain by data cell mapping module 350 upon confirmation of the completed transaction. Thus, user 240 indicates the desire to purchase the plane ticket, and upon the applicable trusted member consenting to and confirming their participation in the transaction, the forwarding link is sent to the trusted member for completion of the transaction event with the specific payment device and subsequent confirmation of the completed transaction is transmitted to the trusted chain.

In some embodiments, transactions typically may be “endorsed” before being committed to the trust chain while transactions which are not endorsed are disregarded. A typical endorsement policy allows chaincode to specify endorsers for a transaction in the form of a set of peer nodes that are necessary for endorsement. This specifies the set of peers on a channel that must execute chaincode and endorse the execution results in order for the transaction to be considered valid; however, the disclosure is not limited to such requirements. When a client sends the transaction to the peers specified in the endorsement policy, the transaction is executed to validate the transaction. After validation, the transactions enter an ordering phase in which a consensus protocol may be used to produce an ordered sequence of endorsed transactions grouped into links of the trusted chain.

Data cell mapping module 350 is configured to perform mapping of data cells to the trusted chain in addition to other applicable data cells including payment device information associated with but not limited to payment device payment details with bank account details, transaction amounts, and due dates for payment device payments. Mappings may be stored in payment device module database 360, which may serve as a map store. In some embodiments, pointers of the trusted chain and sub-chains are mapped to one or more of the plurality of data cells in order to close the loop associated with sub-chains. The mapping that facilitates the closing of the sub-chains may be triggered by one or more actions performed by user 240 such as, but not limited to a request for a payment device option, execution of a payment device transaction, etc. However as previously mentioned, closing of the sub-chains may be facilitated by actions of other trusted members. For example, the loop of the sub-chain may be completed by the trusted member that holds the payment device that the transaction or payment device option that user 240 desires is associated with, in which the trusted member may handle the transaction and data cell mapping module 350 closes the loop by mapping transaction confirmation data to the sub-chain.

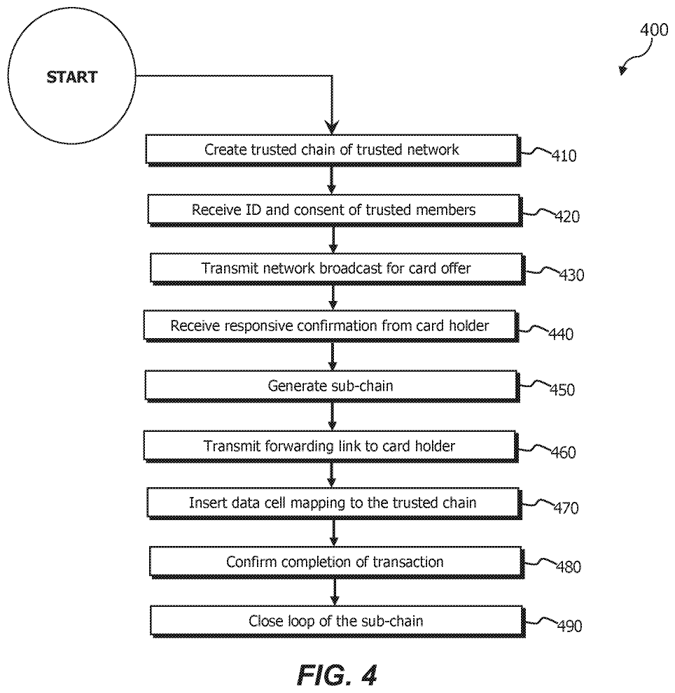

With the foregoing overview of the example architecture, it may be helpful now to consider a high-level discussion of an example process. FIG. 4 depicts a flowchart illustrating a computer-implemented process 400 for maximizing payment options, consistent with an illustrative embodiment. Process 400 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 410 of process 400, trusted network platform 230 generates the trusted chain. In a preferred embodiment, the trusted network associated with the trusted chain comprising friends and family of user 240 who are the trusted members. User 240 and trusted members are added to the trusted network upon trusted network platform 230 receiving consent and at least one unique ID of the trusted members. In some embodiments, the consent and unique IDs are provided to trusted network platform 230 by a creator who is configured to serve as a route source of authority in a manner in which preauthorized consent of trusted members regarding payment device information is allocated to the creator. In another exemplary embodiment, the present application may be embody by a blockchain, distributed ledger, etc. rather than a trusted chain in which the creator would serve as a chain validator during a consensus process. It should be noted that generation of the trusted chain and/or linked list serves a primary purpose in providing a mechanism for trusted members of the trusted network to reuse options on each other payment devices in a secure environment.

At step 420 of process 400, trusted network platform 230 receives the ID and consent of trusted members of the trusted network. It should be noted that step 420 may be performed continuously in which trusted members may be assigned a unique ID associated with the trusted chain as their consent is being acquired. Gathering of consent associated with the sharing of payment device information not only facilitates the assigning of the unique IDs, but also allows the trusted chain to function in manner that prevents trusted members from missing out on options/opportunities due to them not possessing a particular payment device, circumvents trusted members sharing sensitive data (e.g. payment device information, etc.) over unsecure networks, and incentivizes trusted members utilizing payment devices within the trusted network. As previously mentioned, not only is the trusted network designed to include multiple sub-chains derived from the trusted chain, but also trusted members may be members of multiple trusted networks subject to approval from authority sources of each respective trusted network.

At step 430 of process 400, payment device module 250 transmits the network broadcast for one or more payment device options. It should be noted that payment device options and/or options may be provided to user 240 on computing device 245 for selection in a variety of manners such as pop-ups, social media marketing, email marketing, search engine optimization, or any applicable type of advertising known to those of ordinary skill in the art. Payment device module 250 is configured to aggregate payment device options specific to payment devices possessed by trusted members, in which a payment device option being selected by user 240 initiates payment device module 250 transmitting the network broadcast of the payment device option to the trusted member who holds the particular payment device associated with the payment device option.

At step 440 of process 400, payment device module 250 receives responsive confirmation from the trusted member who holds the payment device associated with the payment device option. It should be noted that one of the primary purposes of transmitting a confirmation of the trusted member in response to the network broadcast is to ensure that the trusted member approves of the transaction that user 240 is attempting with the particular payment device associated with the payment device option. If the confirmation is not received from the applicable trusted member, then the process of trusted network platform 230 generating the sub-chain cannot begin because the trusted member has not approved use of their payment device.

At step 450 of process 400, trusted network platform 230 generates the sub-chain of the trusted chain. It should be noted that trusted network platform 230 generates the sub-chain based on payment device module 250 communicating that it has received confirmation of participation of the applicable trusted member in response to the network broadcast associated with the option. In some embodiments, sub-chain creation is created per broadcast of an intent to purchase an option associated with a payment device of a trusted member, in which wherein user 240 initiates the request. It is possible for trusted network platform 230 to operate multiple sub-chains in an active or closed state within the primary chain. These chains are initiated only after the primary chain of trusted parties are created. Trusted network platform 230 generates the sub-chain based on the payment device information associated with the transaction involving the payment device, in which the data cells may be used as the mechanism to initiate the generation of the sub-chain and include payment device information specifically related to the payment device involved in the transaction.

At step 460 of process 400, payment device module 250 transmits the forwarding link the trusted member. As previously mentioned, payment device module 250 generates the forwarding link in which the forwarding link serves as mechanism for the applicable trusted member who holds the relevant payment device to access one or more of a webpages associated with the product or service of the network request, a deal payment link of the product or service, an amount of the transaction, the address of user 240, or any other applicable data pertaining to the product or service of the network request that assists the trusted member with involvement in the transaction. In some embodiments, one or more actions of user 240 with the payment device option automatically initiates sharing of the forwarding link with the trusted member. For example, user 240 may be presented a shopping cart including the product or service associated with the payment device option in which the forwarding link is a redirecting link to the shopping cart transmitted to the trusted member.

At step 470 of process 400, data cell mapping module 350 inserts the data cell mapping into the trusted chain. Data cell mapping module 350 maps the data cells to pointers of the trusted chain and/or sub-chains in order to provide transaction confirmations, payment details, privatized bank account details, payment device payment due dates, and other applicable payment device information derived from the trusted member payment device information and the specific transaction information. For example, user 240 purchasing a payment device option associated with the payment device of the trusted member results in user 240 being provided with data pertaining to when the payment of the payment device bill that includes the transaction is due.

At step 480 of process 400, payment device module 250 confirms the transaction is completed. Transaction event completion is confirmed by not only user 240 or the trusted member in the instance where the trusted member completes the transaction, but also data cell mapping module 350 maps the pointer of the sub-chain to a first node of the data cell including the payment details resulting in the closing of the loop of the sub-chain. However, if a transaction is not completed then the sub-chain remains open due to the loop not being closed. For example, if user 240 initiates the transaction process and subsequently changes their mind, then the loop remains open until user 240 maps the pointer of the sub-chain to close the loop. In another example, in the instance in which a trusted member volunteered to take care of the transaction, but then changed their mind then the trusted member would change the status of the transaction to cancelled and map it to the first node of the data cell associated with the initiated request. In some embodiments, mapping based upon cancellation of the transaction by the trusted member is via a cancel node in which user 240 bears the option of applying for the applicable payment option. It should be noted that transactions may be cancelled up until the moment of completion of the transaction event facilitated by user 240 and/or the applicable trusted member bearing the applicable payment option associated with the option.

At step 490 of process 400, data cell mapping module 350 closes the loop of the sub-chain. The closing of the sub-chain is initiated by the confirmation of the completion of the transaction event in which data cell mapping module 350 maps the pointer of the sub-chain to the first node of the data cell associated with the payment confirmation. However, in some embodiments, cancellation of the request can be accomplished by one or more of user 240 or the payment device bearing trusted member. Data cell mapping module 350 closes the loop of the sub-chain by generating a cancel node signifying either user 240 or the payment device bearing trusted member does not wish to complete the transaction with a predetermined amount of time established by policy module 340. In some embodiments, upon the predetermined amount of time elapsing, the sub-chain may be closed by another trusted member bearing the payment device associated with the option of the transaction in which said trusted member is provided access to a subset of data of the transaction event from the previous uncompleted transaction event that does not include payment device data of the previously involved trusted member associated with the applicable payment device.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-payment devices or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter payment device or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for maximizing payment options comprising:
generating, by a computing device, a trusted chain comprising a plurality of data cells, the data cells including at least payment device data of a payment device associated with a user within a trusted network;
transmitting, by the computing device, a broadcast message to the plurality of data cells based on a selection of an option of the payment device, the broadcast message indicating occurrence of a transaction event within the trusted network involving the option;
generating, by the computing device, a sub-chain of the trusted chain associated with the transaction event relating to the option;
selecting, by the computing device, the data cell of the plurality data cells comprising payment device data associated with the sub-chain; and
closing, by the computing device, the sub-chain based on a detected completion of the transaction event.

2. The computer-implemented method of claim 1, wherein generating the trusted chain comprises:
receiving, by the computing device, a plurality of user identifiers and user consent associated with the user from a creator of the trusted chain;
wherein the option is derived from the payment device data of the payment device of at least one trusted member of the trusted network.

3. The computer-implemented method of claim 2, wherein the data cell comprising payment device data associated with the sub-chain comprises a link to the option;
wherein the link is one or more of a deal payment link, a payment device option amount, and an address of the user.

4. The computer-implemented method of claim 3, wherein the at least one trusted member confirms a participation in the option via the link.

5. The computer-implemented method of claim 1, wherein closing the sub-chain comprises:
receiving, by the computing device, an indicator associated with a guest checkout option pertaining to the option; and
transmitting, by the computing device, a shopping cart link associated with the guest checkout option to the user.

6. The computer-implemented method of claim 1, wherein closing the sub chain comprises:
mapping, by the computing device, a pointer of the sub chain to a first node of the data cell comprising payment device data.

7. The computer-implemented method of claim 1, wherein closing the sub chain comprises:
generating, by the computing device, a data cell mapping;
adding, by the computing device, the data cell mapping and the data cell comprising payment device data associated with the sub chain to the trusted chain.

8. A computer program product for maximizing payment options, the computer program product comprising a computer readable storage medium having program instructions embodied therewith, wherein the computer readable storage medium is not a transitory signal per se, the program instructions being executable by a processor to cause the processor to perform a method comprising:
generating a trusted chain comprising a plurality of data cells, the data cells including at least payment device data of a payment device associated with a user within a trusted network;
transmitting a broadcast message to the plurality of data cells based on a selection of an option of the payment device, the broadcast message indicating occurrence of a transaction event within the trusted network involving the option;
generating a sub-chain of the trusted chain associated with the transaction event relating to the option;
selecting the data cell of the plurality data cells comprising payment device data associated with the sub-chain; and
closing the sub-chain based on a detected completion of the transaction event.

9. The computer program product of claim 8, wherein generating the trusted chain comprises:
receiving a plurality of user identifiers and user consent associated with the user from a creator of the trusted chain;
wherein the option is derived from the payment device data of the payment device of at least one trusted member of the trusted network.

10. The computer program product of claim 9, wherein the data cell comprising payment device data associated with the sub-chain comprises a link to the option;
wherein the link is one or more of a deal payment link, a payment device option amount, and an address of the user.

11. The computer program product of claim 10, wherein the at least one trusted member confirms a participation in the option via the link.

12. The computer program product of claim 8, wherein closing the sub-chain comprises:
receiving an indicator associated with a guest checkout option pertaining to the option; and
transmitting a shopping cart link associated with the guest checkout option to the user.

13. The computer program product of claim 8, wherein closing the sub chain comprises:
mapping a pointer of the sub chain to a first node of the data cell comprising payment device data.

14. The computer program product of claim 8, wherein closing the sub chain comprises:
generating a data cell mapping;
adding the data cell mapping and the data cell comprising payment device data associated with the sub chain to the trusted chain.

15. A computer system for maximizing payment options, the computer system comprising:
one or more processors;
one or more computer-readable memories;
program instructions stored on at least one of the one or more computer-readable memories for execution by at least one of the one or more processors, the program instructions comprising:
program instructions to generate a trusted chain comprising a plurality of data cells, the data cells including at least payment device data of a payment device associated with a user within a trusted network;
program instructions to transmit a broadcast message to the plurality of data cells based on a selection of an option of the payment device, the broadcast message indicating occurrence of a transaction event within the trusted network involving the option;
program instructions to generate a sub-chain of the trusted chain associated with the transaction event relating to the option;
program instructions to select the data cell of the plurality data cells comprising payment device data associated with the sub-chain; and
program instructions to close the sub-chain based on a detected completion of the transaction event.

16. The computer system of claim 15, wherein program instructions to generate the trusted chain comprise:
program instructions to receive a plurality of user identifiers and user consent associated with the user from a creator of the trusted chain;
wherein the option is derived from the payment device data of the payment device of at least one trusted member of the trusted network.

17. The computer system of claim 16, wherein the data cell comprising payment device data associated with the sub-chain comprises a link to the option;
wherein the link is one or more of a deal payment link, a payment device option amount, and an address of the user.

18. The computer system of claim 17, wherein the at least one trusted member confirms a participation in the option via the link.

19. The computer system of claim 18, wherein the at least one trusted member confirms a participation in the option via the link.

20. The computer system of claim 15, wherein program instructions to close the sub chain comprise:
program instructions to generate a data cell mapping;
program instructions to add the data cell mapping and the data cell comprising payment device data associated with the sub chain to the trusted chain.
